(19) United States
(12) Patent Application Publication
(10) Pub. No.: US 2013/0097172 A1
(43) Pub. Date: Apr. 18, 2013

(54) METHOD AND APPARATUS FOR INDEXING AND RETRIEVING MULTIMEDIA WITH OBJECTIVE METADATA

(71) Applicant: Zachary McIntosh, Bozeman, MT (US)

(72) Inventor: Zachary McIntosh, Bozeman, MT (US)

(21) Appl. No.: 13/439,838

(22) Filed: Apr. 4, 2012

Related U.S. Application Data
(60) Provisional application No. 61/471,237, filed on Apr. 4, 2011.

(51) Int. Cl. G06F 17/30

(52) U.S. Cl. CPC G06F 17/3002; G06F 17/30038
USPC 707/741

(57) ABSTRACT

A method and system for indexing, searching, retrieving, and viewing multimedia content employs metadata. The multimedia content is stored in the system, along with associated two types of metadata: (1) objective metadata and (2) subjective metadata. The associated objective metadata contains the values of various objective parameters that pertain to the creation of the multimedia content. Examples of such objective parameters include focal length of the camera used, the recording medium (film or digital), dimensional view (2D or 3D), source of light, light temperature, selected focus (fore, mid, or background), camera motion, recorded frame rate, and rendered playback frame rate. The associated subjective metadata pertains to the subjective content of the multimedia and typically consists of at least one keyword or tag that describes the subjects, themes, or genres depicted by the multimedia content. A user may search for, retrieve, and view the multimedia content by employing search techniques to both the objective and subjective metadata stored in the system.

### CROSS-REFERENCE TO RELATED APPLICATION(S)

This application claims the benefit of U.S. Provisional Application No. 61/471,237, filed on Apr. 4, 2011 and titled MULTIMEDIA INDEXING AND ASSOCIATED SYSTEMS AND METHODS, which is incorporated herein by reference in its entirety.

### BACKGROUND

Many types of multimedia works, such as video clips, audio recordings, and photographs, are now routinely represented and stored digitally. As the number of works increases, there is an increasing need for effective databases to store the works. Companies such as iStockPhoto LP of Calgary, Canada have developed large and diverse databases containing millions of distinct digital multimedia works. Users of these databases desire efficient search and retrieval of multimedia works that are of potential of interest. Typically, databases assist search by associating or “tagging” each work with at least one keyword that relates to the content of the work. For example, a video clip showing a man downhill skiing in Colorado may be tagged with the keywords “skiing,” “Colorado,” and “man.” Often, the party that submits the work to the database manually chooses and enters the keywords that are used to index the work within the database. After a multimedia work has been tagged with at least one associated keyword, a user of the database can search for and retrieve the multimedia work using various Boolean combinations of the keywords.

### BRIEF DESCRIPTION OF THE DRAWINGS

FIG. 1 is a network diagram of a representative environment in which the indexing and retrieving system operates

FIG. 2 is a high-level block diagram showing an example of the architecture of a computing device.

FIG. 3 illustrates multiple embodiments of operating indexing and retrieval systems.

FIG. 4 is a logical block diagram of an embodiment of an indexing and retrieval system.

FIG. 5 is a flow chart of a process for uploading and indexing a multimedia file.

FIG. 6 is a flow chart of a process for search and retrieval of multimedia files.

### DETAILED DESCRIPTION

A method and system for indexing, searching, and retrieving multimedia items is disclosed (hereinafter the “indexing and retrieval system” or the “system”). The system allows a user to search for, retrieve, and display multimedia items using metadata associated with the multimedia item. The metadata corresponds to specific properties of the multimedia item. In particular, the system uses both subjective and objective metadata to characterize the multimedia item. Subjective metadata relates to subjective attributes of the content of the multimedia item. Typically, subjective metadata includes arbitrarily selected keywords or tags that describe subjective elements of the multimedia item. In contrast, objective metadata specifies values for a set of properties common to a particular type of content. For example, objective metadata might relate to technologies used to capture, create, or render the multimedia data, such as parameters associated with the cameras, lenses, microphones, and film stock used during the creation of the multimedia item. Other objective metadata might relate to artistic elements of the multimedia item, such as light source, light temperature, and focus depth associated with the multimedia. A user can then use objective metadata search criteria to search for multimedia content having specific objective properties of interest to the user. In some embodiments, the system allows a user to search using both objective and subjective metadata.

The indexing and retrieval system includes a computing device, a multimedia search engine, and a multimedia database. The database contains multimedia content encoded in digital formats and in some embodiments stored in digital multimedia files. Examples of multimedia content include video clips, audio clips, still photographs, and combinations thereof. The system is configured to enable the bi-directional transfer of data and commands between the computing device, search engine, and database. In some embodiments, this bi-directional communication may be enabled by the use of a network. Additionally, the search engine can search for entries in the database, retrieve entries from the database, and deliver the retrieved entries to the computing device. The computing device may also include a display component to display the retried multimedia content to a user.

In addition to multimedia content, the database stores metadata associated with each multimedia item. The database contains two metadata types: (1) objective metadata and (2) subjective metadata. The objective metadata includes values of various objective parameters pertaining to the creation and content of the multimedia items. Some objective metadata parameters may be associated with multiple multimedia content types (e.g., video, still images, etc.), while other objective metadata parameters may be associated with only a single type of multimedia content. For example, parameters such as focal length of the camera used, the recording medium (film or digital), dimensional view (2D or 3D), source of light, light temperature, and selected focus (fore, mid, or background) are applicable of both video and still images. Similarly, parameters such as camera motion, recorded frame rate, and rendered playback frame rate may apply only to video clips. In addition to the objective metadata, the system may also store subjective metadata, such as keywords or tags that pertain to the subjective content of the multimedia content. In general, the database will store both objective metadata and subjective metadata for the associated multimedia content.

The system allows a user to update and/or submit multimedia content to the database and to associate metadata with the submitted multimedia content. In some embodiments, some or all of the metadata may be determined and submitted to the database through an automated process. However, in other embodiments, the system may require a user to manually specify some or all of the metadata.

The system is configured such that the search engine can search the database based on both objective and subjective metadata values. The system retrieves and presents some or all multimedia items with associated metadata that match specified search parameters. By using appropriate search criteria, a user may retrieve all multimedia content with associated metadata, both objective and subjective, within the range of values defined by the user's interest.

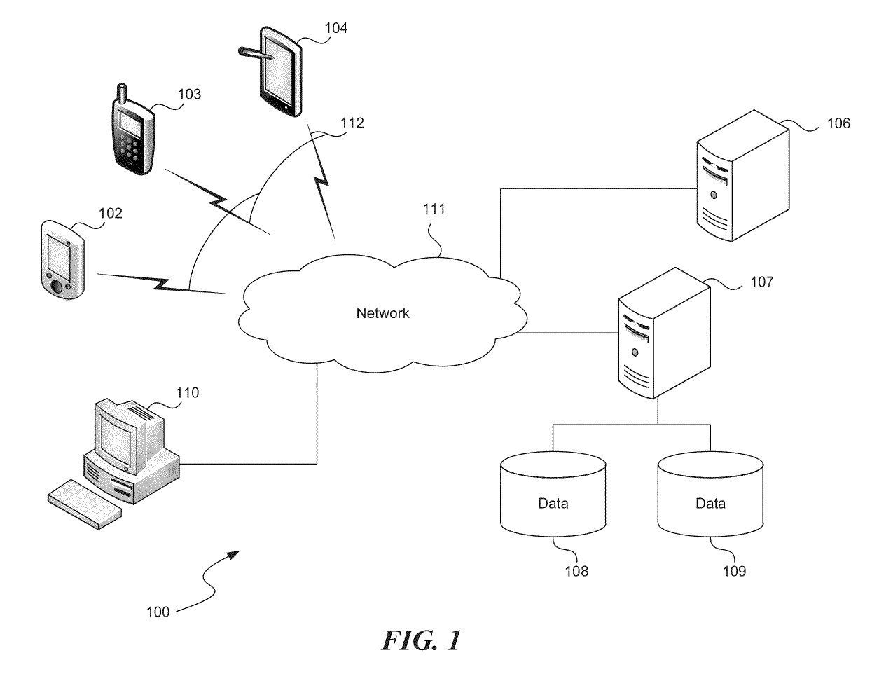

FIG. 1 is a network diagram of a representative environment 100 in which the indexing and retrieving system operates. However, not all of these components may be required to practice the invention. Variation in the arrangement and type of components may be made without departing from the spirit of scope of the invention.

As illustrated in FIG. 1, the environment 100 includes an indexing server 107 which provides a uniform platform for indexing, searching, and retrieving multimedia content. The indexing server 107 is connected to data storage devices 108 and 109. The environment 100 may further include an additional server 106 in communication, by way of a network 111, with the indexing server 107. The additional server 106 may be a third party server and may provide additional services, such as advertising, social networking, or analytic services. It will be understood that servers 106 and 107 may represent several computing devices. Network 111 may be a public network, such as the Internet or a private network connection. Network 111 may be a wired network, wireless network, or a combination of wired and wireless networks.

The environment 100 also includes computing devices operated by end users, such as conventional personal computers (“PCs”) 110 and mobile devices. The mobile devices may include personal data assistants (PDAs) 102, web-enabled smart phones 103, and tablet computing devices 104. The end user devices communicate with the indexing server 107 via network 111. The end user devices may communicate with the network 111 by employing wired or wireless connections, such as the wireless connections 112. The wireless connections 112 could be implemented using any system for transmitting digital data. For example, the connection could use a cellular network implementing Global System for Mobile Communications (GSM), Universal Mobile Telephone Services (UMTS), Long-Term Evolution (LTE), or CDMA2000 or a non-cellular network implementing WiFi (IEEE 802.11) or Bluetooth.

The network 111 may include one or more wireless networks, a wired network, a local area network (LAN), a wide area network (WAN, a direct connection such as through Universal Serial Bus (USB) port, and the like, and may include the set of interconnected networks that make up the Internet.

The indexing server 107, additional server 106, and end user devices 102, 103, 104, 110 each represent computing devices which may generally include any device that is configured to perform computation and that is capable of sending and receiving data communications by way of one or more wired and/or wireless communication interfaces.

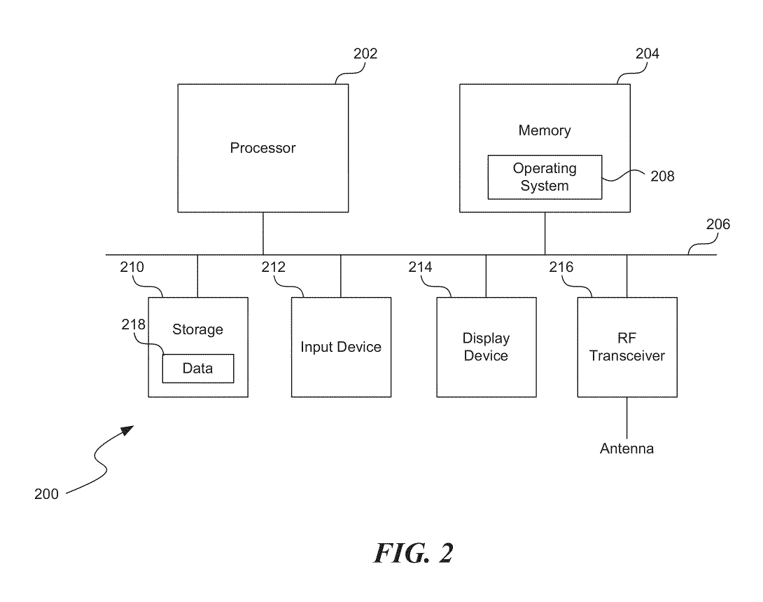

FIG. 2 is a high-level block diagram showing an example of the architecture of a computing device 200. The device 200 may represent any of the computing devices of FIG. 1. The device 200 comprises one or more processors 202 and memory 204 coupled to an interconnect 206. The interconnect 206 shown in FIG. 2 is an abstraction that represents any one or more separate physical buses, one or more point-to-point connections, or both buses and point-to-point connections connected by appropriate bridges, adapters, or controllers. The interconnect 206, therefore, may comprise, for example, a system bus, a Peripheral Component Interconnect (PCI) family bus, a HyperTransport or industry standard architecture (ISA) bus, a small computer system interface (SCSI) bus, a universal serial bus (USB), a IIC (I2C) bus, or an Institute of Electrical and Electronics Engineers (IEEE) standard 1394 bus, sometimes referred to as “Firewire.”

The processor(s) 202 may comprise central processing units (CPUs) of the device 300 and, thus, control the overall operation of the device 200. In certain examples, the processor(s) 202 accomplish this by executing software or firmware stored in the memory 304. The processor(s) 202 may be, or may comprise, one or more programmable general purpose or special purpose microprocessors, digital signal processors (DSPs), programmable controllers, application-specific integrated circuits (ASICs), programmable logic devices (PLDs), or the like, or a combination of such devices.

The memory 204 is, or comprises, the main memory of the device 200. The memory 204 represents any form of fixed or removable random access memory (RAM), read-only memory (ROM), flash memory, or the like, or a combination of such devices. In use, the memory 304 stores, among other things, an operating system 208 of the device 200.

The device 200 comprises an input device 212, which enables a user to control the device. The input device 212 may comprise a keyboard, trackpad, touch sensitive screen, or other standard computer input device. The device 200 also comprises a display device 214 suitable for displaying a user interface. The display may comprise a liquid-crystal display (LCD), a plasma display, a vacuum fluorescent display, a light-emitting diode (LED) display, a field emission display, and/or other suitable types of display configured to present a user interface. The device 200 further comprises a radio frequency (RF) transceiver 216 that provides the device 200 with the ability to communicate with remote devices over a network and may be, for example, a wireless adapter. The device 200 may further comprise local storage 210 coupled to the interconnect 206. The local storage 210 may comprise, for example, a flash memory device that is configured to provide mass storage and that stores data 218 used by the mobile device.

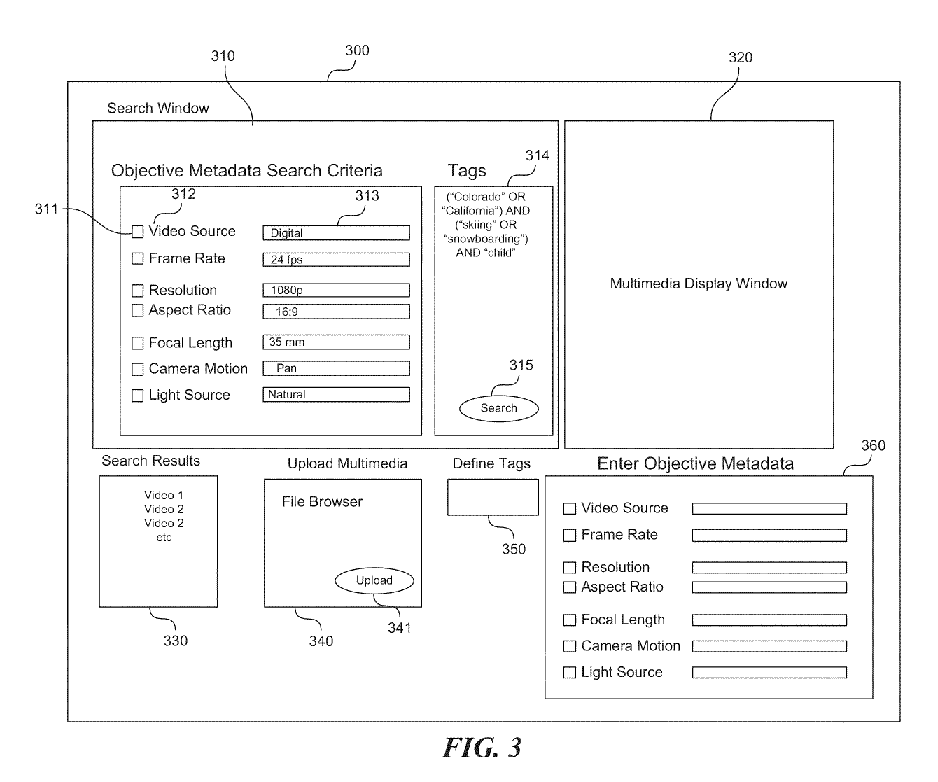

FIG. 3 illustrates an exemplary graphical user interface (“GUI”) that enables a user to search, retrieve, and view multimedia items using both objective and subjective metadata. The GUI additionally enables a user to select and upload one or more multimedia items to the system. The GUI further enables a user to select and associate objective and subjective metadata with one or more selected multimedia items. The user can enter metadata before, during, or after the uploading process. Furthermore, the metadata may be entered in stages and by multiple users. For instance, a user may initially define one or more metadata values during the upload process. Another user, when viewing the uploaded multimedia item, may supply additional metadata values to be associated with the multimedia item. Furthermore, the system may control which users are enabled to provide metadata values to be associated with multimedia items. In some embodiments, all users may provide metadata values. In other embodiments, only certain users may provide metadata values. The ability of a user to provide metadata values may be based on connections within a social network, such as Facebook. In some embodiments, the system may allow for collaborative editing of metadata by a community of users. The collaborative editing may be supported by a Wiki-style user interface that allows for metadata to be edited by registered users, regardless of any relationship with the original uploader. The GUI 300 may be displayed on a user's computing device, such as a PC 110, a PDA 102, a smartphone 103, or a tablet 104.

The GUI includes a primary window 300, which includes a search window 310. The search window 310 enables a user to select objective parameters that will be included in a search. The search window 310 lists objective parameters that the user may select, such as Video Source, Frame Rate, Resolution, and Aspect Ratio. The Search Window additionally has a select box 311 for each objective parameter. A user can select the select boxes to include in the corresponding objective parameters in the search. The search window 310 also includes an input region 313 for each selected objective parameter to enable the user to define search values or ranges of search values for each of the selected objective parameters. In some embodiments, the objective parameters may be arranged and grouped logically according to aspects of the objective characteristics that the parameters pertain to. For instance, all objective parameters relating to properties of photographic lenses may be grouped together. In some embodiments, the objective parameters may be arranged in directory-like cascading windows or pull down menus. The search window 310 also includes an input region 314 to allow the user to enter subjective search terms or tags that will be matched in the search. The user may use logical connectors (e.g., Boolean connectors) to define the search criteria. The primary window 300 includes a search button 315 to initiate a search sequence based on the selected parameters.

The primary search window 300 also includes a display window 330, which displays the search results. The GUI enables a user to select a multimedia item that was located in the search. Upon selection in the window 330, the selected multimedia item may be downloaded to the user's device and displayed in the multimedia display window 320. Alternatively, the system may stream the multimedia item to the user's computing device instead. In some embodiments, multiple multimedia items may be simultaneously selected and viewed. The display window 320 may contain multiple sub-windows to enable the user to view and compare multiple multimedia items simultaneously. Additional details of the search, retrieve, and display process are described below.

The primary window 300 additionally includes a file browser window 340 that allows a user to select a multimedia item to upload to the system. The user can define both the objective and subjective metadata to be associated with the multimedia item in windows 360 and 350, respectively. In addition, the primary window 300 includes an upload button 341, which initiates a system upload of both the selected multimedia item and the associated metadata. In some embodiments, it may be possible to upload multiple multimedia items and associated metadata simultaneously.

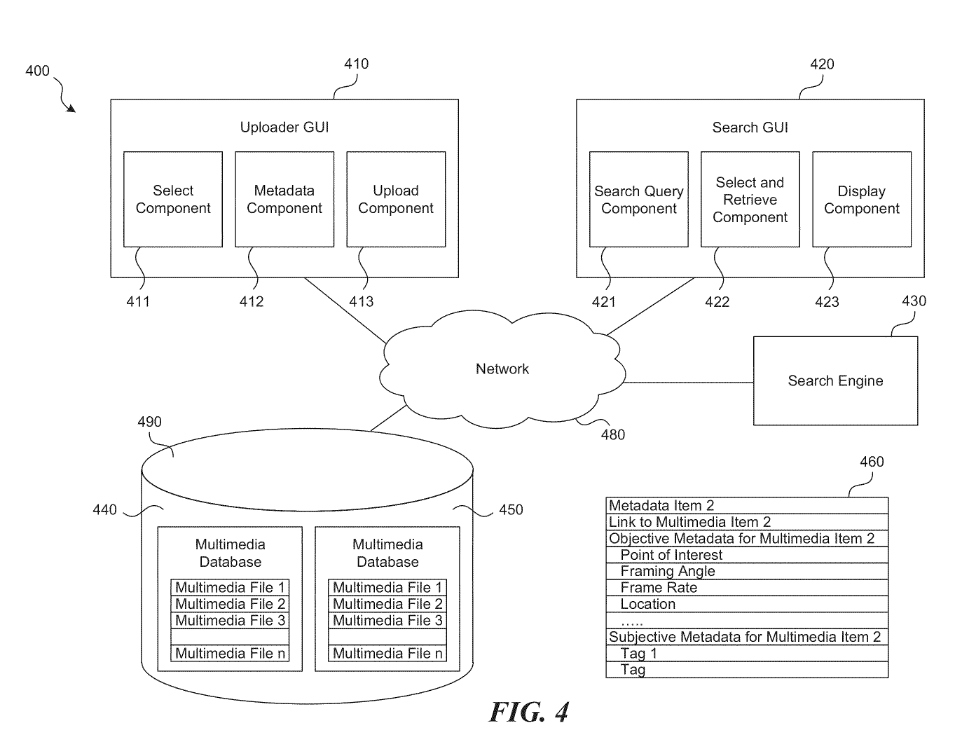

FIG. 4 illustrates the elements of an indexing and retrieval system 400. The elements of system 400 may be implemented on a single computing device, such as one detailed in FIG. 2, or distributed across a plurality of devices. Aspects of this system may be implemented as special purpose hardware circuitry, programmable circuitry, or a combination of these. As will be discussed in additional detail herein, the system 400 comprises a number of modules to facilitate the functions of the system. The modules and their underlying code and/or data may be implemented in a single physical device or distributed over multiple physical devices and the functionality implemented by calls to remote services. Similarly, data could be stored in local storage or remote storage and distributed in one or more physical devices. Assuming a programmable implementation, the code to support the functionality of this system may be stored on a computer-readable medium such as an optical drive, flash memory, or a hard drive. One skilled in the art will appreciate that at least some of these individual modules may be implemented using application-specific integrated circuits (ASICs), programmable logic devices (PLDs), or a general-purpose processor configured with software and/or firmware. In one embodiment, the system 400 is implemented in the index, search, and retrieve server 107 and data repositories 108 and 109, shown in FIG. 1.

As shown in FIG. 4, system 400 includes a generalized communication network 480. The network 480 enables bi-directional communication amongst the elements of system 400. The network 480 may be implemented by one or more wireless network, a wired network, a local area network (LAN), a wide area network (WAN, a direct connection such as through Universal Serial Bus (USB) port, or other another physical bus, and the like, and may include the set of interconnected networks that make up the Internet.

As shown in FIG. 4, system 400 includes a multimedia database 440 and a metadata database 450. The multimedia database 440 contains the data that digitally encodes each of the multimedia items. The metadata database 450 contains metadata associated with each multimedia item in the multimedia database 440. In some embodiments a single database may be used to store both multimedia items and their associated metadata. The multimedia database 440 and the metadata database 450 may be stored on a single data repository 490, or distributed across a plurality of data repositories.

The multimedia database 440 includes a plurality of multimedia items 441-445. In some embodiments, the multimedia items may be stored in a file structure. For example, in some embodiments, each multimedia item is stored in an individual file, such as an audio file or a video file. In other embodiments, a multimedia item may be distributed across a plurality of associated files. In still other embodiments, multiple multimedia items may be stored in a single file. It will be appreciated that formats other than files systems may be implemented to store the multimedia items 441-445 in the multimedia database 440.

The metadata database 450 includes a plurality of metadata items 451-454. Each metadata item is associated with a corresponding multimedia item. In some embodiments, metadata items are stored in individual files, such as metadata files. In other embodiments, a metadata item may be distributed across a plurality of associated files. In still other embodiments, multiple metadata items may be stored in an individual file. In still other embodiments, the metadata item may be stored in the same file that stores the associated multimedia item. It will be appreciated that formats other than files systems may be implemented to include the multimedia items in the multimedia database 440.

Each metadata item includes a plurality of values that indicate attributes of the associated multimedia item. In some embodiments, the metadata values may be arranged in an organized data structure, such as key/value pairs, a hierarchy, linked lists, or an object-oriented class. Some of the metadata values correspond to objective parameters of the associated multimedia item. The metadata values may also describe subjective content of the associated multimedia item. The metadata values may also provide a link to the associated multimedia item, such as a file name, hyperlink, or pointer in a file structure. The metadata values may also provide a basic description for the multimedia item, such as the title, author, or copyright owner of the multimedia item.

Generally speaking, subjective metadata values indicate subjective content of the associated multimedia item. The subjective metadata value may include one or more keywords or tags that are indicative of the content of the multimedia item. For instance, if the multimedia item is a video clip of a boy playing soccer, one subjective metadata value may be the word “soccer”. Another subjective metadata value may be the word “boy”. These subjective keywords are generally selected by the user that uploads the multimedia item based on subjective impressions of the multimedia item. In some embodiments, users other than the one that uploaded the multimedia file may provide one or more subjective keywords or tags. In some embodiments, a limit may exist regarding the number of subjective metadata values that are included in a metadata item. In other embodiments, the number of subjective metadata values included in a metadata item may be limited only by the storage space available in the system.

Generally speaking, objective metadata parameters indicate objective attributes of the associated multimedia item (i.e., attributes that can be determined based on objective criteria). These objective metadata parameters provide predefined structure for associating specific information with the metadata items. Objective parameters may be given useful names, such as “focal_length”, “light_source”, and “light_temperature”, where the names are indicative to what type of information is stored in the metadata value. For each multimedia item, values are associated with one or more of the possible objective parameters. The objective metadata parameters associated with each multimedia item may be dependent on the particular type of multimedia item. Some objective parameters may be available for all types of multimedia items, while other objective parameters may only be appropriate for certain types of multimedia items. The following discussion of objective parameters relates to objective parameters primarily associated with photography or video technologies that are used to create multimedia items. However, it will be appreciated that other objective parameters are appropriate for other technologies, such as audio recordings and the like, and the objective parameters for any embodiment are not limited to those discussed herein.

In order to harmonize search strategies; some embodiments may employ a highly structured set of objective metadata parameters. Such sets may include specific parameters with ranges of values and names that are appropriate for a particular multimedia type. In some embodiments, multiple sets of objective metadata parameters are available, depending on the associated multimedia type. In some embodiments, users may add further metadata parameters to such existing sets. In some embodiments, a single multimedia item may have multiple associated metadata items. Furthermore, in some embodiments, each associated metadata item may further be associated with a particular user, or group of users, such as a social network. The system may associate metadata parameters with a multimedia item based on the values of other parameters. For instance, parameters relating to resolution or sample rate may only be included in a particular metadata item if the value of another parameter in the metadata item=“digital”.

The objective metadata may include information characterizing aspects of the creation or content of the associated multimedia item. For example, some of the objective metadata parameters may relate to the relative location of subjects depicted in the multimedia item. Such parameters may include the location of a main subject depicted in the multimedia item based on a Cartesian, polar, or other appropriate coordinate systems. If multiple subjects are depicted in the multimedia item, multiple parameters indicating the relative coordinates of each subject may be associated with the multimedia item.

Another objective parameter may indicate whether images depicted in the multimedia items are sharp and in focus, as opposed to defocussed. Other objective parameters may relate to the depth of focus in a particular scene. Values for such objective parameters may include foreground, mid-ground, background, or the like. Other exemplary objective metadata parameters may indicate movements of the camera used to capture the multimedia item. Such a parameter might have values indicating tilt, pan, roll, or the shifting of optics off the perpendicular axis to create atypical field ranges. Other exemplary metadata parameters may indicate and characterize time dependent focusing, such as the use of a time-dependent defocus/focus effect.

Another objective parameter may indicate the focal length of the lens used to capture a scene. If multiple lenses are used to capture a scene, multiple parameters may be used, with associated names such as “focal_length_{—}0”, “focal_length_{—}1”, “focal_length_{—}2”, etc. Another objective parameter may indicate if film, analog video, or digital video is used to capture a scene. If the value of such an objective parameter is “film”, another parameter may indicate the size of the film in millimeters (“mm”). If the value of the parameter indicates that digital video was used, another set of parameters may indicate the resolution in pixels and the number of bits associated with each pixel for the raw video data. Another objective parameter may indicate the aspect ratio of the multimedia item. Another objective parameter may indicate the field of view, or solid angle, of the scene in steradians. Another objective parameter may indicate if the view is a horizontal, vertical, or side view. Another objective parameter may indicate if the depicted scene is two-dimensional or three dimensional in nature. If the scene is three dimensional, another objective parameter may indicate if the scene is rendered with three-dimensional techniques. If so, a set of objective parameters may indicate information regarding the three-dimensional techniques employed. For three-dimensional scenes, other objective parameters may indicate the location of the “viewer” in Cartesian coordinates with respect to a particular subject depicted in the scene.

The values of some objective parameters may be derived or calculated from the values of other objective parameters (referred to as “independent objective parameters”). In some embodiments, the system automatically calculates the values of derivable objective parameters after the system receives the corresponding independent objective parameters. In other cases, the system may determine objective parameters based on other derived objective parameters. Examples of derived objective parameters include the horizontal, vertical, and diagonal degrees of view, which all depend on a camera's focal length (f). For instance, if h, v, and d correspond to the height, width, and diagonal length of a full frame camera sensor, respectively, then

$$\text{?} degree of view = 2 arctan \frac{b}{2 f} \text{?}$$

$$\text{?} degree of view = 2 arctan \frac{v}{2 f} \text{?}$$

$$\text{?} degree of view = 2 arctan \frac{d}{2 f} \text{?}$$

$$\text{?} \text{indicates text missing or illegible when filed}$$

The system may generate additional objective parameters based on the degree of view objective parameters. For example, the system may assign a “field of view” objective parameter corresponding to predefined ranges of values of the degree of view objective parameters. The parameter might be assigned values, such as Ultra Wide, Wide, Normal, Long, Medium Telephoto, Super Telephoto, or Macro, corresponding to these predefined ranges.

Other objective parameters may further indicate the overall composition type, the horizontal composition angle, or the vertical composition angle of the multimedia item. For example, the composition type may have values such as extreme long shot (ELS), long shot (long shot), medium shot (2 shot and over the shoulder—MS), close up shot (CUS), and extreme close up (ECU). Similarly, the horizontal composition angle may have values such as frontal, ¾ front, profile, ¾ rear, and rear. The vertical composition angle may have values such as bird's eye, high level, neutral view, low view, worms eye view, and Dutch tilt.

Other objective parameters may indicate the recorded frame rate of the multimedia. Still other objective parameters may indicate the rendered frame rate. Some objective parameters may indicate compression technologies employed for the rendered video. Objective parameters may indicate compression ratios, bitrate, frame rate, and other values associated with the employed compression technologies.

Other objective parameters may indicate the number and model of cameras used to capture a scene. Still other objective parameters indicate the light source used to illuminate a scene while the scene was captured. For instance, objective parameters may indicate that the source of light was natural sunlight or an artificial lighting source. Other parameters may indicate the location of various sources of light in Cartesian coordinates. Other parameters may indicate the light temperature in Kelvins.

In some embodiments, a derived objective parameter may be determined automatically, by the value of the objective value of the light temperature. For instance, a derived objective parameter, such as color temperature, may be a category of light temperature that reflects predefined ranges of the light temperature. Such categories of color temperature may include: Match Flame, Candle Flame, Sunset or Sunrise, Tungsten Bulbs 500-1000 watts, Quartz Lights, Fluorescent Lights, Tungsten 2K, Tungsten 5K, 10K, Direct Sun at Noon, Daylight/sun+sky and Sun through Clouds/Haze, Sky/overcast, RGB monitor, Outdoor shade, and Sky Partly Cloundy.

Still other parameters may indicate data regarding any digital processing performed on the raw footage before it is rendered. Other objective parameters may indicate degrees of view and optical compression ranges. Other objective metadata parameters may include time stamp information relating to the time when the multimedia item was created or modified. Still other objective parameters may include multiple timestamps associated with a single multimedia item. For instance, one time stamp can be indicative of the rendering date of the multimedia. Another time stamp may be the date and time the multimedia item was uploaded to the system. Another time stamp may be indicate the last time that the multimedia item was viewed by a particular user. Other objective parameters may indicate the total cumulative number of times that the multimedia item was viewed by all users or a particular user of the system. Other objective metadata parameters may include geographic coordinates or address information indicating the location of the scene.

This listing of potential objective parameters is intended only as an exemplary list and is not meant to be exhaustive of the objective parameters that may be employed for multimedia items using still or video photography. As described below, when metadata parameters are associated with a multimedia item, values do not need to be indicated for every possible objective parameter.

The system 400 also includes an uploader graphical user interface (GUI) 410. The uploader GUI 410 enables a user to upload a multimedia item to the system 400. The uploader GUI 410 may run on end user devices, such as PDAs 102, smartphones 103, tablets 104, or PCs 110, the indexing server 107, or the additional server 106. The uploader GUI 410 includes a select component 411 that enables the user to select an individual multimedia item to be uploaded to the system. In some embodiments, the select component 411 enables a user to select multiple multimedia items simultaneously.

The uploader GUI 410 additionally includes a metadata component 412. The metadata component 412 allows a user to specify objective and subjective metadata to associate with the multimedia items that are to be uploaded. In some embodiments, the user may specify metadata for multimedia items that have already been uploaded to the system and multimedia items that may be uploaded to the system in the future. In some embodiments, the user determines and manually enters the metadata with the uploader GUI 410. In other embodiments, some parameters of the metadata may be determined and entered automatically by the system.

The uploader GUI 410 also includes an upload component 413 that uploads the selected multimedia items and the associated metadata into the multimedia database 440 and the metadata database 450.

The system 400 includes a search GUI 420 that enables a user to search for and retrieve multimedia items that are stored in the multimedia database 440. The search GUI 420 runs on end user devices, the indexing server 107, or the additional server 106. The search GUI 420 includes a search query component 421 which enables the user to enter search terms. The search GUI also includes a retrieve component 422, which enables a user to select and retrieve multimedia items that are returned by the search query component 421. In addition, the search GUI 420 includes a display component 423 that enables the display of a selected and retrieved multimedia item.

The system 400 also includes a search engine 430. The search engine 430 is configured to search for multimedia items by finding metadata in the metadata database 450 that matches parameters of the search query generated by the search GUI 420. The search engine returns a listing of multimedia items with matching metadata values. In some embodiments, the search engine returns the metadata values that include the link to the multimedia item. The resulting multimedia items may be displayed in the display component 423. The subjective metadata keywords and tags, as well as the objective parameters may be searched individually, concurrently, or consecutively. Various implementations of search logic may be enabled. Boolean logic operators such as OR, NOR, AND, NAND may be used to connect the objective parameters.

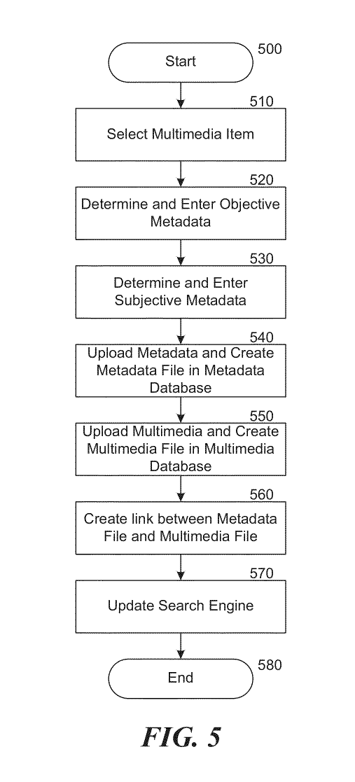

FIG. 5 is a flowchart of a process 500 for uploading and indexing a multimedia item. Processing begins at block 510, where a user selects a multimedia item to be loaded into the system 400. As discussed herein, the select component 411 of the uploader GUI 410 enables the user to select the multimedia item. The multimedia item selected by the user may be currently stored on the computing device that the user is operating the uploader GUI 410 through, some other computing device, or an additional data repository that the user may access through a network, such as the Internet.

Processing then proceeds to block 520, where the objective metadata is determined and entered into the system. The user may determine the objective metadata from various sources, including the user's own knowledge of the multimedia item's creation. As discussed above, some of the objective metadata parameters may be determined through automated means. Some of the objective metadata parameters may be embedded within, or derivable from, already existing metadata associated with the multimedia item or the data of the multimedia item. Processing then proceeds to block 530, where the subjective metadata is determined and entered into the system. In some embodiments, blocks 520 and 530 may be combined into a single step. For both blocks 520 and 530, the user may enter the objective and subjective metadata using the metadata component 412 of the uploader GUI 410.

Processing then proceeds to block 540, where the objective and subjective metadata entered in blocks 520 and 530 is uploaded from the uploader GUI 410 to the metadata database 450. In some embodiments, the system creates a metadata file 460 in the data repository 490 to store the associated metadata. In some embodiments, the metadata is arranged in a hierarchical data structure such as a linked list or object-oriented class. In some embodiments, the metadata file may be first created by the uploader GUI 410 and uploaded for storage. In other embodiments, the metadata may be uploaded as discreet values. The indexing server 106, or some other computing device, may then create the metadata file based on the discreet values. Alternatively, the system may store the metadata in a single repository, such as a relational database.

Processing then proceeds then proceeds to block 550, where the selected multimedia item is uploaded from the uploader GUI 410 to the multimedia database 440. In some embodiments, a multimedia file is created to be stored in the data repository 490. In some embodiments, the multimedia item may exist in multimedia file form before it is selected for uploading by the user. In other embodiments, the multimedia file may be first created by the uploader GUI 410 and uploaded.

Processing then proceeds to block 560, where the system creates a link between the multimedia file and the associated metadata. In some embodiments, the multimedia data and the metadata reside in a single file and no link creating the association between the two files is needed. The processing then proceeds to block 570, where the multimedia database 440 and the metadata database 450 are updated with the contents of the newly uploaded multimedia item and the associated metadata.

It should be noted that it is not required that the metadata be supplied contemporaneously with the selecting and uploading of the multimedia item. For example, some metadata may be supplied during the upload process and other metadata may be supplied at some point in the future. In some embodiments, the user may supply some metadata while uploading the multimedia item, while other users may supply some of the other metadata at later times. In some embodiments, all users of the system can supply metadata to be associated with a multimedia item. In other embodiments, only users in privileged groups, such as super users, or users within the content providers' social network, are permitted to supply metadata.

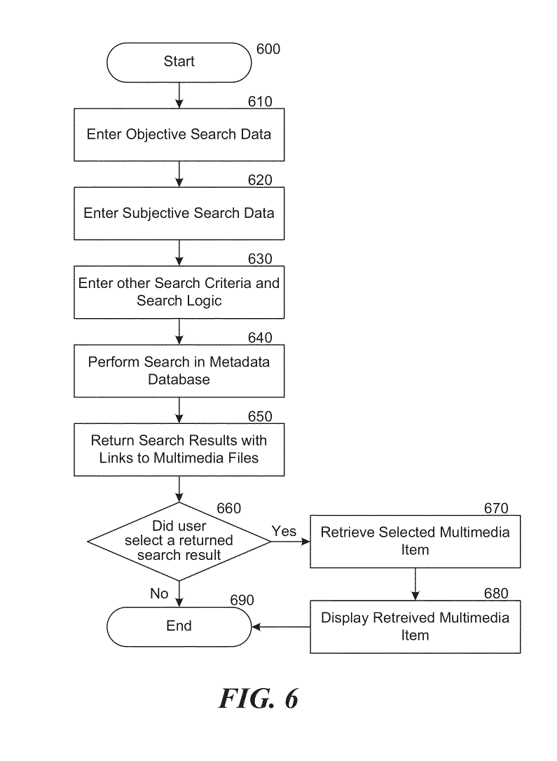

FIG. 6 is a logical flow diagram of a process 600 for search and retrieval of multimedia files that have objective and subjective metadata. Processing begins at block 610, where a user enters values for the objective metadata parameters that will be searched. As discussed above, the search query component 421 of the search GUI 420 may be used to enter search criteria. The user may select one or more of the objective parameters to search for. Depending on the nature of a selected objected parameter, the user may enter a single value or a range of values for the search engine to match.

Processing then proceeds to block 620, where the user enters the values for the subjective metadata to search for. As discussed above, the search query component 421 of the search GUI 420 is used to enable the user to enter search criteria. The user may select one or more keywords or tags to search for. For example, if the user is interested in video clips showing a man downhill skiing in Colorado may select keywords “skiing,” “Colorado,” and “man.”

Processing then proceeds to block 630, where the user may define and enter other search criteria in the search query component 421. For instance the user may define Boolean combinations of objective parameters and subjective keywords or tags. The user may use Boolean logical operators such as OR, NOR, AND, NAND, etc to define search logic. Some embodiments of the invention may also enable users to use wildcard characters.

Processing then proceeds to block 640, where the search is performed. The search query and logic are sent to the search engine 430 over the network 480. In block 650, the search results are sent from the search engine 430 over the network 480 to the search GUI 420 and presented to the user in the retrieve component 422. If the user selects one of the search results, the multimedia content is then retrieved in block 670 and displayed to the user in the display component 423 in block 680. The user can then continue selecting, retrieving, and viewing the search results, or perform another search by re-entering the search criteria.

I/We claim:

1. A computer-implemented method for indexing and retrieving multimedia items from a multimedia database, the method comprising:
storing multiple multimedia items in the multimedia database;
storing at least one item of objective metadata associated with an individual multimedia item of the multiple multimedia item in the multimedia database, wherein the objective metadata corresponds to a characteristic of the multimedia item that can be objectively determined;
storing at least one item of subjective metadata associated with an individual multimedia item of the multiple multimedia items in the multimedia database, wherein the subjective metadata corresponds to a subjective characteristic of the associated multimedia item;
receiving a search query specifying search parameters including at least one objective metadata parameter;
retrieving from the multimedia database a list of multimedia items matching the received search query; and
presenting at least a portion of the list of multimedia items to a user.

2. The method of claim 1, wherein the at least one item of objective metadata characterizes an objective attribute relating to at least one of the creation of the individual multimedia item, the content of the individual multimedia item, or the rendering or playback of the individual multimedia item.

3. The method of claim 1, wherein the individual multimedia item comprises at least photographic or video content.

4. The method of claim 3, wherein the at least one item of objective metadata characterizes an objective attribute of a lens element used to capture the photographic or video content.

5. The method of claim 3, wherein the at least one item of objective metadata characterizes an objective attribute of a light source that illuminates an element in the photographic or video content.

6. The method of claim 3, wherein the at least one item of objective metadata characterizes a relative location of an element in the photographic or video content.

7. The method of claim 3, wherein the at least one item of objective metadata characterizes an objective attribute of a medium used to record the photographic or video content.

8. The method of claim 3, wherein the at least one item of objective metadata characterizes an objective attribute of a data object that encodes the photographic or video content.

9. The method of claim 1, wherein the individual multimedia item includes audio content and wherein the at least one item of objective metadata characterizes an objective attribute of an acoustic to electric transducer element used to capture the audio content.

10. A computer-readable non-transitory storage medium for storing computer-executable instructions for indexing and retrieving multimedia items from a multimedia database, by a method comprising:
storing multiple multimedia items in the multimedia database;
storing at least one item of objective metadata associated with an individual multimedia item of the multiple multimedia item in the multimedia database, wherein the objective metadata corresponds to a characteristic of the multimedia item that can be objectively determined;
storing at least one item of subjective metadata associated with an individual multimedia item of the multiple multimedia items in the multimedia database, wherein the subjective metadata corresponds to a subjective characteristic of the associated multimedia item;
receiving a search query specifying search parameters including at least one objective metadata parameter;
retrieving from the multimedia database a list of multimedia items matching the received search query; and
presenting at least a portion of the list of multimedia items to a user.

11. The computer-readable storage medium of claim 10, wherein the at least one item of objective metadata characterizes an objective attribute relating to at least one of the creation of the individual multimedia item, the content of the individual multimedia item, or the rendering or playback of the individual multimedia item.

12. The computer-readable storage medium of claim 10, wherein the individual multimedia item comprises at least photographic or video content.

13. The computer-readable storage medium of claim 12, wherein the at least one item of objective metadata characterizes an objective attribute of a lens element used to capture the photographic or video content.

14. The computer-readable storage medium of claim 12, wherein the at least one item of objective metadata characterizes an objective attribute of a light source that illuminates an element in the photographic or video content.

15. The computer-readable storage medium of claim 12, wherein the at least one item of objective metadata characterizes a relative location of an element in the photographic or video content.

16. The computer-readable storage medium of claim 12, wherein the at least one item of objective metadata characterizes an objective attribute of a data object that encodes the photographic or video content.

17. The computer-readable storage medium of claim 10, wherein the individual multimedia item includes audio content and wherein the at least one item of objective metadata characterizes an objective attribute of a data object that encodes the audio content.

18. A system for indexing and retrieving multimedia items from a multimedia database, comprising:
a processor;
a memory;
a multimedia database configured to store:
multiple multimedia items, and
at least one item of objective metadata associated with an individual multimedia item of the multiple multimedia item in the multimedia database, wherein the objective metadata corresponds to a characteristic of the multimedia item that can be objectively determined; and
at least one item of subjective metadata associated with an individual multimedia item of the multiple multimedia items in the multimedia database, wherein the subjective metadata corresponds to a subjective characteristic of the associated multimedia item;
a query component configured to receive a search query specifying search parameters including at least one objective metadata parameter;
a retrieval component configured to retrieve from the multimedia database a list of multimedia items matching the received search query; and
a display component configured to present at least a portion of the list of multimedia items to a user.

19. The system of claim 18, wherein the at least one item of objective metadata characterizes an objective attribute relating to at least one of the creation of the individual multimedia item, the content of the individual multimedia item, or the rendering or playback of the individual multimedia item.

20. The system of claim 18, wherein the individual multimedia item comprises at least photographic or video content.

21. The system of claim 20, wherein the at least one item of objective metadata characterizes an objective attribute of a lens element used to capture the photographic or video content.

22. The system of claim 20, wherein the at least one item of objective metadata characterizes an objective attribute of a light source that illuminates an element in the photographic or video content.

23. The system of claim 20, wherein the at least one item of objective metadata characterizes an objective attribute of a medium used to record the photographic or video content.

24. The system of claim 18, wherein the individual multimedia item includes audio content and wherein the at least one item of objective metadata characterizes an objective attribute of an acoustic to electric transducer element used to capture the audio content.

25. The system of claim 18, wherein the individual multimedia item includes audio content and wherein the at least one item of objective metadata characterizes an objective attribute of a data object that encodes the audio content.
